(19) United States
(12) Patent Application Publication
(10) Pub. No.: US 2023/0163455 A1
(43) Pub. Date: May 25, 2023

(54) MOBILE DEVICE FOR REDUCING SPECIFIC ABSORPTION RATE

(71) Applicant: Acer Incorporated, New Taipei City (TW)

(72) Inventors: Kun-Sheng CHANG, New Taipei City (TW); Ching-Chi LIN, New Taipei City (TW)

(21) Appl. No.: 17/700,062

(22) Filed: Mar. 21, 2022

(30) Foreign Application Priority Data
Nov. 24, 2021 (TW) 110143659

(51) Int. Cl. H01Q 1/52; H01Q 9/04; H01Q 1/48

(52) U.S. Cl. CPC H01Q 1/52; H01Q 9/0421; H01Q 1/48

(57) ABSTRACT

A mobile device for reducing SAR (Specific Absorption Rate) includes a ground element, a first radiation element, a second radiation element, and a third radiation element. The ground element has a slot. The first radiation element is coupled to a feeding point. The second radiation element is coupled to the ground element. The third radiation element is coupled to the feeding point and has a hollow portion. The third radiation element is substantially surrounded by the ground element, the first radiation element, and the second radiation element. An antenna structure is formed by the ground element, the first radiation element, the second radiation element, and the third radiation element.

### CROSS REFERENCE TO RELATED APPLICATIONS

This application claims priority of Taiwan Patent Application No. 110143659 filed on Nov. 24, 2021, the entirety of which is incorporated by reference herein.

### BACKGROUND OF THE INVENTION

### Field of the Invention

The disclosure generally relates to a mobile device, and more particularly, it relates to a mobile device and an antenna structure therein.

### Description of the Related Art

With the advancements being made in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi and Bluetooth systems and using frequency bands of 2.4 GHz, 5.2 GHz, and 5.8 GHz.

An antenna is an indispensable component in a mobile device that supports wireless communication. However, the antenna is easily affected by adjacent metal components, which often interfere with the antenna and degrade the overall communication quality. Alternatively, the SAR (Specific Absorption Rate) may be too high to comply with regulations and laws. Accordingly, there is a need to propose a novel solution for solving the problems of the prior art.

### BRIEF SUMMARY OF THE INVENTION

In an exemplary embodiment, the disclosure is directed to a mobile device for reducing SAR (Specific Absorption Rate). The mobile device includes a ground element, a first radiation element, a second radiation element, and a third radiation element. The ground element has a slot. The first radiation element is coupled to a feeding point. The second radiation element is coupled to the ground element. The third radiation element is coupled to the feeding point and has a hollow portion. The third radiation element is substantially surrounded by the ground element, the first radiation element, and the second radiation element. An antenna structure is formed by the ground element, the first radiation element, the second radiation element, and the third radiation element.

In some embodiments, the first radiation element substantially has a short L-shape, and the second radiation element substantially has a long L-shape.

In some embodiments, the second radiation element includes a wide portion and a narrow portion, and the narrow portion is coupled through the wide portion to the ground element.

In some embodiments, the slot of the ground element is a closed slot and substantially has a straight-line shape.

In some embodiments, the hollow portion of the third radiation element substantially has a rectangular shape.

In some embodiments, a first coupling gap is formed between the third radiation element and the second radiation element. A second coupling gap is formed between the third radiation element and the ground element. The width of each of the first coupling gap and the second coupling gap is from 0.5 mm to 2 mm.

In some embodiments, the antenna structure covers a first frequency band, a second frequency band, a third frequency band, and a fourth frequency band. The first frequency band is from 1710 MHz to 2170 MHz. The second frequency band is from 2300 MHz to 2700 MHz. The third frequency band is from 3300 MHz to 3800 MHz. The fourth frequency band is from 5150 MHz to 5850 MHz.

In some embodiments, the length of the first radiation element is substantially equal to 0.25 wavelength of the second frequency band.

In some embodiments, the length of the second radiation element is substantially equal to 0.25 wavelength of the first frequency band or 0.5 wavelength of the third frequency band.

In some embodiments, the length of the third radiation element is substantially equal to 0.25 wavelength of the fourth frequency band.

### BRIEF DESCRIPTION OF DRAWINGS

The invention can be more fully understood by reading the subsequent detailed description and examples with references made to the accompanying drawings, wherein:

FIG. 1 is a top view of a mobile device according to an embodiment of the invention;

FIG. 2 is a diagram of radiation gain of an antenna structure of a mobile device according to an embodiment of the invention; and

FIG. 3 is a perspective view of a mobile device according to an embodiment of the invention.

### DETAILED DESCRIPTION OF THE INVENTION

In order to illustrate the purposes, features and advantages of the invention, the embodiments and figures of the invention are shown in detail below.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to other elements or features as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

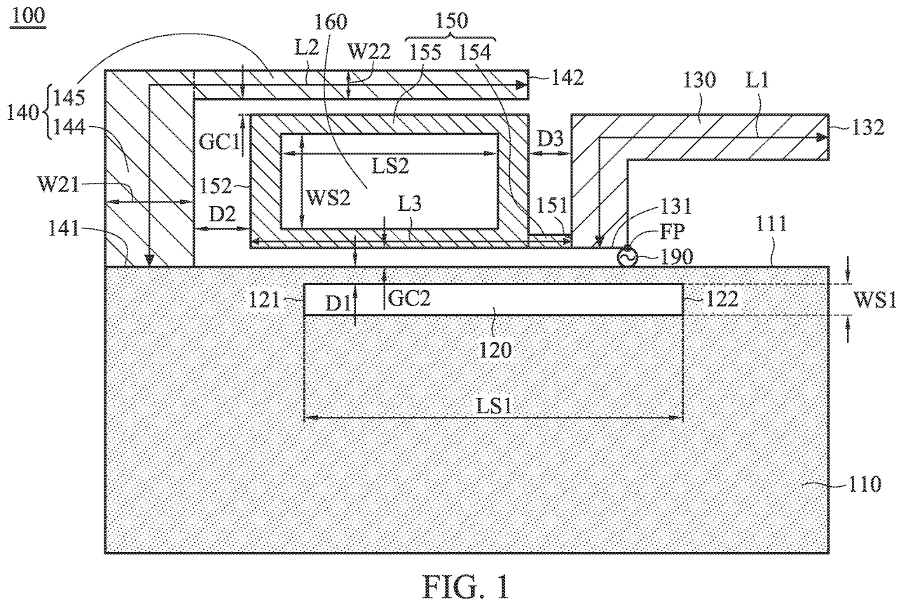

FIG. 1 is a top view of a mobile device 100 according to an embodiment of the invention. In the embodiment of FIG. 1, the mobile device 100 includes a ground element 110, a first radiation element 130, a second radiation element 140, and a third radiation element 150. The ground element 110, the first radiation element 130, the second radiation element 140, and the third radiation element 150 may all be made of metal materials, such as copper, silver, aluminum, iron, or their alloys. It should be understood that the mobile device 100 may further include other components, such as a processor, a touch control panel, a speaker, a battery module, and a housing, although they are not displayed in FIG. 1.

The ground element 110 can provide a ground voltage. The ground element 110 has a slot 120, which may substantially have a straight-line shape. For example, the slot 120 may be a closed slot with a first closed end 121 and a second closed end 122 away from each other. In addition, the slot 120 may be substantially parallel to the edge 111 of the ground element 110.

The first radiation element 130 may substantially have a short L-shape. Specifically, the first radiation element 130 has a first end 131 and a second end 132. The first end 131 of the first radiation element 130 is coupled to a feeding point FP. The second end 132 of the first radiation element 130 is an open end. The feeding point FP may be further coupled to a signal source 190. For example, the signal source 190 may be an RF (Radio Frequency) module for exciting an antenna structure of the mobile device 100.

The second radiation element 140 may substantially have a long L-shape. Specifically, the second radiation element 140 has a first end 141 and a second end 142. The first end 141 of the second radiation element 140 is coupled to the ground element 110. The second end 142 of the second radiation element 140 is an open end. For example, the second end 142 of the second radiation element 140 and the second end 132 of the first radiation element 130 may substantially extend in the same direction. In some embodiments, the second radiation element 140 is a variable-width structure, and includes a wide portion 144 adjacent to the first end 141 and a narrow portion 145 adjacent to the second end 142. The narrow portion 145 is coupled through the wide portion 144 to the ground element 110. It should be noted that the term “adjacent” or “close” over the disclosure means that the distance (spacing) between two corresponding elements is smaller than a predetermined distance (e.g., 5 mm or shorter), or means that the two corresponding elements directly touch each other (i.e., the aforementioned distance/spacing therebetween is reduced to 0).

The third radiation element 150 may substantially have a P-shape with a hollow portion 160, and the hollow portion 160 may substantially have a rectangular shape. The third radiation element 150 is substantially surrounded by the ground element 110, the first radiation element 130, and the second radiation element 140. Specifically, the third radiation element 150 has a first end 151 and a second end 152. The first end 151 of the third radiation element 150 is coupled to the feeding point FP. The second end 152 of the third radiation element 150 is an open end. In some embodiments, the third radiation element 150 includes a connection portion 154 adjacent to the first end 151 and a loop portion 155 adjacent to the second end 152, and the hollow portion 160 is surrounded by the loop portion 155. Furthermore, a first coupling gap GC1 is formed between the third radiation element 150 and the second radiation element 140, and a second coupling gap GC2 is formed between the third radiation element 150 and the ground element 110.

In a preferred embodiment, the antenna structure of the mobile device 100 is formed by the ground element 110, the first radiation element 130, the second radiation element 140, and the third radiation element 150. The antenna structure may be disposed on a dielectric substrate (not shown). For example, the dielectric substrate may be a PCB (Printed Circuit Board) or an FPC (Flexible Printed Circuit), but it is not limited thereto.

According to practical measurements, the antenna structure of the mobile device 100 can cover a first frequency band, a second frequency band, a third frequency band, and a fourth frequency band. The first frequency band may be from 1710 MHz to 2170 MHz. The second frequency band may be from 2300 MHz to 2700 MHz. The third frequency band may be from 3300 MHz to 3800 MHz. The fourth frequency band may be from 5150 MHz to 5850 MHz. Therefore, the antenna structure of the mobile device 100 can support at least the wideband operations of the next 5G (5th Generation Wireless System) communication.

In some embodiments, the operational principles of the antenna structure of the mobile device 100 are described below. The second radiation element 140 can be excited to generate a fundamental resonant mode, thereby forming the aforementioned first frequency band. The first radiation element 130 can be excited to generate the aforementioned second frequency band. The second radiation element 140 can be further excited to generate a higher-order resonant mode, thereby forming the aforementioned third frequency band. The third radiation element 150 can be excited to generate the aforementioned fourth frequency band. In addition, according to practical measurements, the antenna structure of the mobile device 100 can significantly reduce the SAR (Specific Absorption Rate) by about 75% within the aforementioned third frequency band since the slot 120 and the hollow portion 160 change the current distribution on the ground element 110 and the third radiation element 150 and also decrease the current density thereof.

In some embodiments, the element sizes of the mobile device 100 are described below. In the ground element 110, the length LS1 of the slot 120 may be from 20 mm to 30 mm, and the width WS1 of the slot 120 may be from 1 mm to 3 mm. The length L1 of the first radiation element 130 may be substantially equal to 0.25 wavelength (λ/4) of the aforementioned second frequency band. The length L2 of the second radiation element 140 may be substantially equal to 0.25 wavelength (λ/4) of the aforementioned first frequency band or 0.5 wavelength (λ/2) of the aforementioned third frequency band. In the second radiation element 140, the width W21 of the wide portion 144 may be from 3 mm to 5 mm, and the width W22 of the narrow portion 145 may be from 1 mm to 3 mm. The length L3 of the third radiation element 150 may be substantially equal to 0.25 wavelength (λ/4) of the aforementioned fourth frequency band. In the third radiation element 150, the length LS2 of the hollow portion 160 may be from 8 mm to 12 mm, and the width WS2 of the hollow portion 160 may be from 4 mm to 6 mm. The width of the first coupling gap GC1 may be from 0.5 mm to 2 mm. The width of the second coupling gap GC2 may be from 0.5 mm to 2 mm. The distance D1 between the slot 120 and the edge 111 of the ground element 110 may be from 2 mm to 3 mm. The distance D2 between the loop portion 155 of the third radiation element 150 and the wide portion 144 of the second radiation element 140 may be from 2 mm to 4 mm. The distance D3 between the loop portion 155 of the third radiation element 150 and the first radiation element 130 may be from 2 mm to 4 mm. The above ranges of element sizes are calculated and obtained according to the results of many experiments, and they help to optimize the SAR, the operational bandwidth, and the impedance matching of the antenna structure of the mobile device 100.

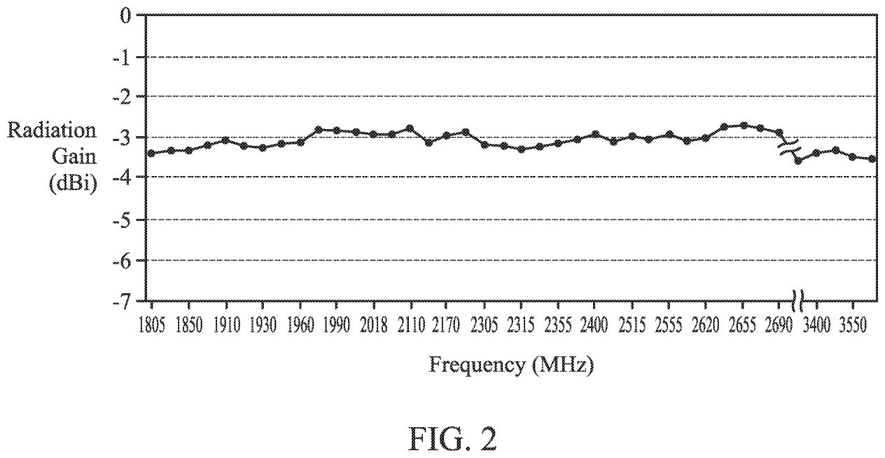

FIG. 2 is a diagram of the radiation gain of the antenna structure of the mobile device 100 according to an embodiment of the invention. The horizontal axis represents the operational frequency (MHz), and the vertical axis represents the radiation gain (dBi). According to the measurement of FIG. 2, the radiation gain of the antenna structure of the mobile device 100 can be greater than −4 dBi within the first frequency band, the second frequency band, the third frequency band, and the fourth frequency band as mentioned above. It can meet the requirements of practical application of general mobile communication devices.

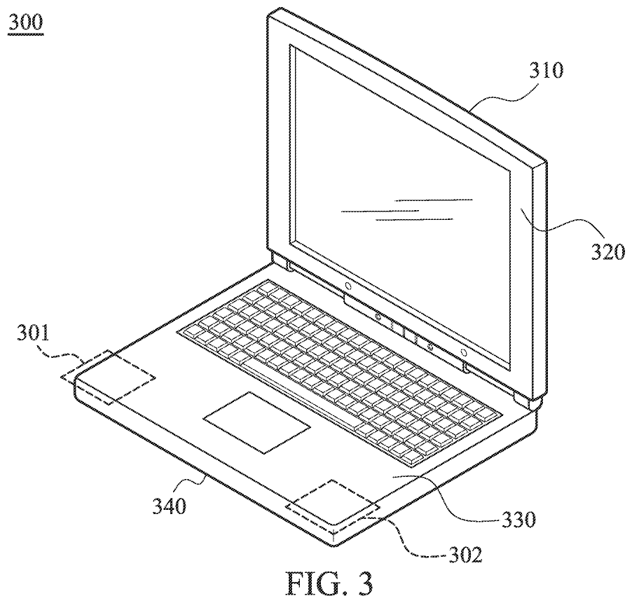

FIG. 3 is a perspective view of a mobile device 300 according to an embodiment of the invention. In the embodiment of FIG. 3, the mobile device 300 is a notebook computer and includes an upper cover housing 310, a display frame 320, a keyboard frame 330, and a base housing 340. It should be understood that the upper cover housing 310, the display frame 320, the keyboard frame 330, and the base housing 340 are equivalent to the so-called “A-component”, “B-component”, “C-component” and “D-component” in the field of notebook computers, respectively. The antenna structure described in the previous embodiments may be disposed at a first position 301 or a second position 302 adjacent to a corner of the keyboard frame 330, but it is not limited thereto. According to practical measurements, such a design can help to minimize the SAR of the antenna structure of the mobile device 300. Other features of the mobile device 300 of FIG. 3 are similar to those of the mobile device 100 of FIG. 1. Accordingly, the two embodiments can achieve similar levels of performance.

The invention proposes a novel mobile device and its antenna structure. Compared to the conventional design, the invention has at least the advantages of low SAR, small size, wide bandwidth, low manufacturing cost, and good communication quality, and therefore it is suitable for application in a variety of mobile communication devices.

Note that the above element sizes, element shapes, and frequency ranges are not limitations of the invention. An antenna designer can fine-tune these settings or values according to different requirements. It should be understood that the mobile device and antenna structure of the invention are not limited to the configurations of FIGS. 1-3. The invention may merely include any one or more features of any one or more embodiments of FIGS. 1-3. In other words, not all of the features displayed in the figures should be implemented in the mobile device and antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device for reducing SAR (Specific Absorption Rate), comprising:
a ground element, having a slot;
a first radiation element, coupled to a feeding point;
4 a second radiation element, coupled to the ground element;
5 a third radiation element, coupled to the feeding point, and having a hollow portion, wherein the third radiation element is substantially surrounded by the ground element, the first radiation element, and the second radiation element;
wherein an antenna structure is formed by the ground element, the first radiation element, the second radiation element, and the third radiation element.

2. The mobile device as claimed in claim 1, wherein the first radiation element substantially has a short L-shape.

3. The mobile device as claimed in claim 1, wherein the second radiation element substantially has a long L-shape.

4. The mobile device as claimed in claim 1, wherein the second radiation element comprises a wide portion and a narrow portion.

5. The mobile device as claimed in claim 4, wherein the narrow portion is coupled through the wide portion to the ground element.

6. The mobile device as claimed in claim 1, wherein the slot of the ground element is a closed slot and substantially has a straight-line shape.

7. The mobile device as claimed in claim 1, wherein the hollow portion of the third radiation element substantially has a rectangular shape.

8. The mobile device as claimed in claim 1, wherein a first coupling gap is formed between the third radiation element and the second radiation element.

9. The mobile device as claimed in claim 8, wherein a second coupling gap is formed between the third radiation element and the ground element.

10. The mobile device as claimed in claim 9, wherein a width of each of the first coupling gap and the second coupling gap is from 0.5 mm to 2 mm.

11. The mobile device as claimed in claim 1, wherein the antenna structure covers a first frequency band, a second frequency band, a third frequency band, and a fourth frequency band.

12. The mobile device as claimed in claim 11, wherein the first frequency band is from 1710 MHz to 2170 MHz, the second frequency band is from 2300 MHz to 2700 MHz, the third frequency band is from 3300 MHz to 3800 MHz, and the fourth frequency band is from 5150 MHz to 5850 MHz.

13. The mobile device as claimed in claim 11, wherein a length of the first radiation element is substantially equal to 0.25 wavelength of the second frequency band.

14. The mobile device as claimed in claim 11, wherein a length of the second radiation element is substantially equal to 0.25 wavelength of the first frequency band or 0.5 wavelength of the third frequency band.

15. The mobile device as claimed in claim 11, wherein a length of the third radiation element is substantially equal to 0.25 wavelength of the fourth frequency band.
